(19) United States
(12) Patent Application Publication
(10) Pub. No.: US 2005/0096169 A1
(43) Pub. Date: May 5, 2005

(54) Pulley for transmission belt and pulley system

(76) Inventor: James W. Reichard II, St. Leonard, MD (US)

Correspondence Address: James W. Reichard II, 5231 Apple Way, St. Leonard, MD, 20685, US

(21) Appl. No.: 10/699,684

(22) Filed: Nov. 4, 2003

(51) Int. Cl. F16H 55/30

(52) U.S. Cl. 474/152; 474/170

(57) ABSTRACT

The present invention comprises a pulley for a transmission belt and pulley system. The pulley of the present invention is designed to interact with current, off-the-shelf transmission belts to improve belt life and system performance. The invention accomplishes these objectives by providing a novel pulley tooth design that significantly increases belt life along with the addition of surface gaps across the teeth to increase gripping between the belt and the pulley, and holes through the pulley sides and the pulley face to reduce air trapped between the belt and pulley face, reducing hydroplaning.

### BACKGROUND OF THE INVENTION

1. Field of the Invention

The present invention pertains in general to transmission belt and pulley systems, particularly to transmission belt and pulley systems wherein the belt and pulley have teeth and or grooves that interact, and more particularly to an improved pulley used in transmission belt and pulley systems having interacting teeth that provides improved belt life.

2. Description of the Related Art

Since the inception of belt and pulley transmission systems, automotive manufacturers have striven to improve the working life of the belt. Belt replacement is not only a cost issue for general automotive vehicles, but is a major timing and efficiency issue for higher performance, competitive automobiles in the racing community.

Initially, transmission belts and pulleys were designed having flat contact surfaces. However, this configuration provided for too much side to side action, due to slippage, creating severe belt wear. In order to address this problem, transmission belts and pulleys were designed having matching “teeth” to minimize side-to-side action, thereby increasing the life of the belt.

The present standard serpentine belt design provides a 40 degree, V-style rib with an extremely narrow point at its tip. The current pulley design provides inverted 40 degree V-style rib teeth, which completely encircle the outer face of the pulley. These rib teeth are designed to match the V-style ribs on the belt as closely in form and number as possible, so the rib teeth rest directly within the ribs, to minimize side-to-side action on the belt. While this design provided a slight increase in belt life over previous designs, as well as decreasing engine noise, as the belt wears in this configuration, the pulley and belt only contact at the points of V ribs/teeth, reducing the contact surface area. This causes the belt to slip, and, ultimately, break.

Another problem associated with the current transmission belt and pulley design relates to maintaining maximum contact between the two elements during transmission operation. Due to the round shape of the pulley, as the belt rotates around only a portion of the pulley, the belt has a tendency to pull away from the pulley surface unless a significant tension is maintained. This problem is increased due to air being trapped between the pulley and belt surfaces, creating a hydroplaning effect. These problems also cause belt slippage, which reduces belt life as well as efficiency of the system.

Therefore, it is desired to provide a transmission belt and pulley system that maintains maximum surface area contact during wear of the belt, increases the gripping action between the belt and the pulley, and reduces hydroplaning of the belt.

### SUMMARY OF THE INVENTION

The present invention comprises a pulley for a belt and pulley transmission system that improves belt wear and system performance compared to present pulleys. The pulley accomplishes improved belt life by altering the contact points between the pulley and the belt, allowing the pulley to “wear into” the belt. The pulley of the invention herein also improves the gripping action of the belt on the pulley and reduces hydroplaning, which creates belt slippage, decreasing system performance and belt life.

Accordingly, it is an object of this invention to provide a pulley for a transmission belt and pulley system that increases the life of the belt.

It is a further object of this invention to provide a pulley for a transmission belt and pulley system that improves the gripping action between the belt and the pulley.

A still further object of this invention is to provide a pulley for a transmission belt and pulley system that decreases hydroplaning compared to current belt and pulley systems.

This invention accomplishes these objectives and other needs related to transmission belt and pulley systems by providing an improved pulley for a pulley and belt transmission system. The present invention is designed to be used with a standard transmission belt having V-shaped grooves designed to interact with rows of pulley teeth arranged circumferentially along the pulley face. The V-shaped grooves have a groove pitch angle that is substantially constant so as to provide a series of identical V-shapes along the face of the belt. The pulley teeth have a pulley pitch angle that is less than that of the groove pitch angle. This results in teeth that have a slightly wider V-shape than that of the belt grooves. In operation, this causes the pulley teeth to “work into” the V-shape grooves as the belt wears, creating greater surface area contact as the pulley teeth move into the V-shape grooves.

In a preferred embodiment of the present invention, the tip of the pulley teeth has a flattened shape so direct contact of the tip and the bottom of the V-shape groove of the belt do not contact one another until the belt is completely worn and no “tip-to-tip” contact occurs so as to increase belt wear. In another preferred embodiment of the invention, the pulley also comprises at least one surface gap at an angle to the rows of pulley teeth. This improves the gripping action between the belt and the pulley. In a more preferred embodiment, a plurality of surface gaps along the face of the pulley will be defined by grooves through the face of the pulley. Further, the invention may also comprise at least one hole through a side of the pulley, beneath the pulley face to allow trapped air between the pulley face and the belt to be released.

### BRIEF DESCRIPTION OF THE DRAWINGS

The accompanying drawings, which are incorporated in and constitute a part of the specification, illustrate embodiments of the invention, and, together with the description, serve to explain the principles of the invention.

FIG. 1 is a cut-away side view of a close-up of an embodiment of the pulley teeth and belt grooves of the present invention.

FIG. 2 is an angled view of an embodiment of the pulley of the present invention.

### DESCRIPTION OF THE PREFERRED EMBODIMENT

In present transmission belt and pulley systems, the belts are designed with V-shape grooves and the pulleys with inverted V-shape teeth to interact with the V-shape grooves in order to reduce side-to-side action that results in belt slippage and system noise. In the present system designs, the pitch angle of the belt grooves and the teeth are identical so that the grooves and teeth make maximum contact with one another. The shape of the grooves in teeth are also designed to be identical so that the tip of the teeth contacts the bottom of the V-shape grooves. While this configuration provides for maximum reduction in side-to-side movement of the belt, as the belt wears along the sides of the grooves, the only contact point remaining between the teeth and the belt is at the tip of the teeth and the bottom of the grooves. This results in slippage problems and dramatically decreases the life of the belt.

The invention, as embodied herein, comprises a pulley for a transmission belt and pulley system. The pulley of the present invention is designed to interact with current, off-the-shelf transmission belts to improve belt life and system performance. The invention accomplishes these objectives by providing a novel pulley tooth design that significantly increases belt life along with the addition of surface gaps across the teeth to increase gripping between the belt and the pulley, and holes through the pulley sides and the pulley face to reduce air trapped between the belt and pulley face, reducing hydroplaning.

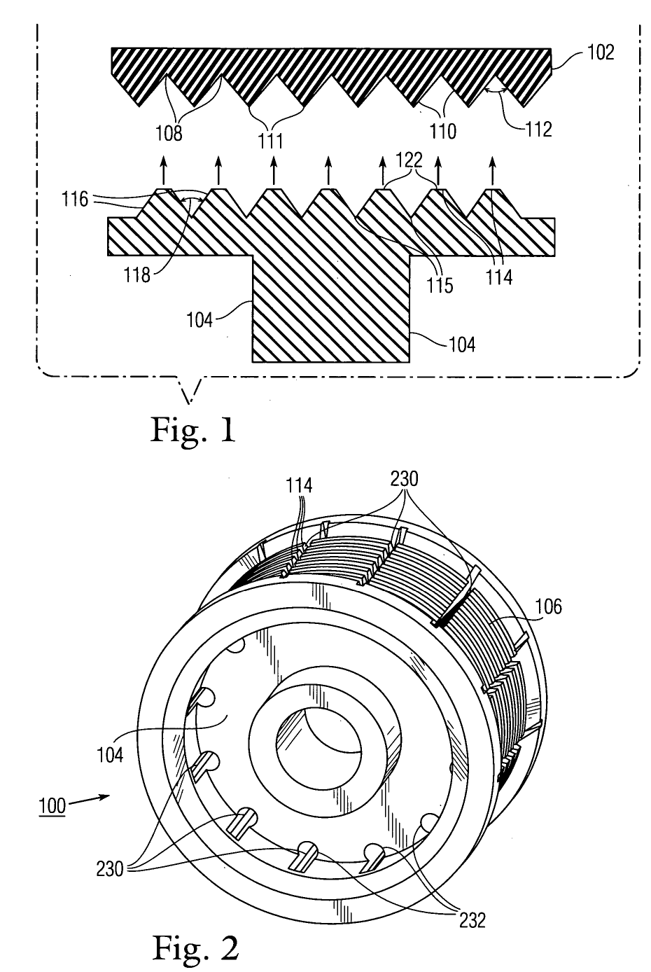

Referring to FIGS. 1 and 2, the invention comprises a pulley 100 for a transmission belt 102 and pulley 100 system. The pulley 100 has two pulley sides 104 and a pulley face 106 between the pulley sides 104. The pulley sides 104 and face 106 are normally oval or circular in shape so the belt 102 can roll along the pulley face 106 as the pulley 100 rotates. The standard belt 102 has a plurality of V-shaped grooves 108. The grooves 108 are defined by a series of angled faces 110 that have a groove pitch 112. The groove pitch 112 is determined by the angle between two of the angled faces 110 as the faces 110 meet at the bottom of the grooves 108. The belt 102 also has a plurality of belt teeth 111 that are formed between the plurality of grooves 108.

A plurality of pulley teeth 114 are aligned circumferentially around the pulley face 106.

The pulley teeth 114 are defined by a series of angled walls 116 that have a pulley teeth pitch 118. The pulley teeth pitch 118 is determined by the angle between two of the angled walls 116 where they meet and form a plurality of pulley grooves 115. In the present invention, the pulley teeth pitch 118 is less than the groove pitch 112.

This results in the pulley teeth 114 being at a wider angle than the angles of the V-shaped grooves 108. Thus, the pulley teeth 114 do not initially fit completely into the V-shaped grooves 108; so, the V-shaped grooves 108 actually must be “forced” around the teeth 114. In operation, because the pulley teeth 114 initially are only partially within the grooves 118, as the belt wears, the pulley teeth 114 more fully enter the grooves 118. In conjunction with this effect, the belt teeth 111 also must be slightly compressed in order to fit into the pulley grooves 115. This creates more surface contact between the angled walls 116 of the teeth 114 and the angled faces 110 of the grooves 108, increasing system performance and decreasing belt 102 wear due to avoidance of the single point contact problem as described above.

In a preferred embodiment of the invention, the pulley teeth pitch 118 is from about one to about ten degrees less than the groove pitch 112. In a more preferred embodiment, the teeth pitch 118 is about two to about eight degrees less than the groove pitch 112. In a most preferred embodiment, the teeth pitch 118 is about five degrees less than the groove pitch 112. It is also preferred that the pulley teeth 114 have a pulley tip 122 with a flattened shape. This flattened shape ensures that the pulley tips 122 will not become a sole point of contact with the bottom 124 of the grooves 108, thereby, significantly decreasing belt life as with current belt and pulley transmission systems as described above.

Because most pulleys 100 are round in shape and belts 102 are flat, the belts have a tendency to naturally pull away from the pulley. To prevent this from occurring, the invention may also include at least one surface gap 230 across, at an angle to, the pulley teeth 114. It is preferred that the at least one surface gap 230 comprise a plurality of grooves across the pulley teeth 114. In a more preferred embodiment of the invention, the plurality of grooves will extend through the surface of pulley face 106. The number of surface gaps 230 depend upon the size of the pulley face 106 and may be selected by one skilled in the art, however, a preferred number is from about two to about twenty surface gaps 230. The dimensions of the surface gaps 230 are selected to increase the gripping action between the belt 102 and the pulley face 106. The surface gaps 230 work by forcing the belt 102 to stretch from one side of the gaps 230 to the other side of the gaps 230 in a gripping action. This helps to keep the belt face 103 against the pulley face 106.

As the belt 102 moves around the pulley 100, air has a tendency to get trapped between the belt 102 and pulley 100. This creates a hydroplaning type of action similar to automobile tires on wet roadways. In order to address this problem, the invention may also include at least one hole 232 through a pulley side 104. The hole 232 should be located beneath the pulley face 106 (opposite to the belt 102). In conjunction with the plurality of gaps 230, the air travels from between the belt 102 and pulley face 106, through the gaps 230 and out through the hole 232, thereby removing the trapped air from the system. Preferably, there will be a plurality of holes 232 through each of the pulley sides 104 and, more preferably, the holes 232 will be located proximate to the bottom of the gaps 230. While the number of pairs of holes depends upon the size of the pulley and may be selected by one skilled in the art, it is preferred that there is approximately one pair of holes through the pulley sides 104 for each gap 230. The size and configuration of the holes may also be selected by one skilled in the art.

What is described are specific examples of many possible variations on the same invention and are not intended in a limiting sense. The claimed invention can be practiced using other variations not specifically described above.

1. A pulley for a pulley and belt transmission system, the belt having grooves defined by a series of angled faces, the faces having a groove pitch angle, comprising:
a pulley face;
a plurality of teeth, having a plurality of pulley tips, circumferentially around the pulley face, defined by a series of angled walls, the walls having a pulley pitch angle less than the groove pitch angle; and,
at least one surface gap across the plurality of teeth.

2. The pulley of claim 1, wherein the pulley pitch angle comprises from about one degree to about 10 degrees less than the groove pitch angle.

3. The pulley of claim 2, wherein the pulley pitch angle comprises from about two degrees to about 8 degrees less than the groove pitch angle.

4. The pulley of claim 3, wherein the pulley pitch angle comprises about five degrees less than the groove pitch angle.

5. The pulley of claim 4, wherein the pulley tip comprise a flattened shape.

6. The pulley of claim 1, wherein the at least one surface gap comprises a plurality of grooves, at an angle to the plurality of teeth, through the pulley face.

7. The pulley of claim 6, from about two to about twenty grooves through the pulley face.

8. The pulley of claim 7, further comprising two pulley sides, the pulley face therebetween, having at least one hole drilled through one of the pulley sides, the at least one hole positioned beneath the pulley face.

9. The pulley of claim 8, comprising a number of hole pairs drilled through the pulley sides about equal to the number of grooves through the pulley face.

10. The pulley of claim 9, wherein the hole pairs comprise a position proximate to the grooves through the pulley face.
